(19) United States
(12) Patent Application Publication
(10) Pub. No.: US 2017/0371159 A1
(43) Pub. Date: Dec. 28, 2017

(54) Lens Assembly with Multiple Lenses for Relaying Images

(71) Applicant: OCULUS VR, LLC, Menlo Park, CA (US)

(72) Inventor: Youngshik Yoon, Cupertino, CA (US)

(21) Appl. No.: 15/195,752

(22) Filed: Jun. 28, 2016

(51) Int. Cl. G02B 27/01; G06F 3/01; G02B 9/06; G06T 19/00

(52) U.S. Cl. CPC G02B 27/0172; G06T 19/006; G06F 3/013; G02B 9/06; G02B 2027/015; G02B 2027/0152

(57) ABSTRACT

A display device includes a two-dimensional array of pixels configured for outputting a respective pattern of light. The display device also includes a lens assembly configured for relaying the respective pattern of light from the two-dimensional array of pixels to a pupil of an eye of a user. The lens assembly includes two or more lenses. The two or more lenses are configured in such a way that a ray of light from a respective pixel of the two-dimensional array of pixels passes through the two or more lenses of the lens assembly.

### TECHNICAL FIELD

This relates generally to display devices, and more specifically to head-mounted display devices.

### BACKGROUND

Head-mounted display devices (also called herein head-mounted displays) are gaining popularity as means for providing visual information to user. However, the size and weight of conventional head-mounted displays have limited applications of head-mounted displays.

### SUMMARY

Accordingly, there is a need for head-mounted displays that are compact and light, thereby enhancing the user's virtual-reality and/or augmented reality experience. In addition, the head-mounted displays should be low power, to ensure a long battery life.

The above deficiencies and other problems associated with conventional head-mounted displays are reduced or eliminated by the disclosed display devices. In some embodiments, the device is a head-mounted display device. In some embodiments, the device is portable.

In accordance with some embodiments, a display device includes a two-dimensional array of pixels configured for outputting a respective pattern of light and a lens assembly configured for relaying the respective pattern of light from the two-dimensional array of pixels to a pupil of an eye of a user. The lens assembly includes two or more lenses. The two or more lenses are configured in such a way that a ray of light from a respective pixel of the two-dimensional array of pixels passes through the two or more lenses of the lens assembly.

In accordance with some embodiments, a lens assembly includes two or more lenses for relaying a respective pattern of light from a two-dimensional array of pixels to a pupil of an eye of a user. The two or more lenses are configured in such a way that a ray of light from a respective pixel of the two-dimensional array of pixels passes through the two or more lenses of the lens assembly.

In accordance with some embodiments, a method is performed at a display device includes a two-dimensional array of pixels and a lens assembly. The method includes outputting a respective pattern of light from the two-dimensional array of pixels; and relaying, using the lens assembly, the respective pattern of light from the two-dimensional array of pixels to a pupil of an eye of a user. The lens assembly includes two or more lenses. The two or more lenses are configured in such a way that a ray of light from a respective pixel of the two-dimensional array of pixels passes through the two or more lenses of the lens assembly.

Thus, the disclosed embodiments provide compact and light display devices with increased efficiency, effectiveness, and user satisfaction with such devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a perspective view of a display device in accordance with some embodiments.

FIG. 2 is a block diagram of a system including a display device in accordance with some embodiments.

FIG. 3 is a schematic diagram illustrating a structure of a display device in accordance with some embodiments.

FIG. 4A is a plan view of an array of pixels in accordance with some embodiments.

FIG. 4B is a schematic diagram illustrating a structure of a diffraction film in accordance with some embodiments.

FIG. 4C is an image of the array of pixels shown in FIG. 4A, with an overlaying diffraction film, in accordance with some embodiments.

FIG. 4D is a plan view of an array of pixels in accordance with some embodiments.

FIG. 4E is an image of the array of pixels shown in FIG. 4D, with the overlaying diffraction film for FIG. 4C, in accordance with some embodiments.

FIG. 4F is an image of the array of pixels shown in FIG. 4D, with another overlaying diffraction film, in accordance with some embodiments.

These figures are not drawn to scale unless indicated otherwise.

### DETAILED DESCRIPTION

Conventional head-mounted displays are larger and heavier than typical eyeglasses, because conventional head-mounted displays often include a complex set of optics that can be bulky and heavy. It is not easy for users wearing such conventional head-mounted displays to get used to wearing such large and heavy head-mounted displays.

The disclosed embodiments, by utilizing a lens assembly, provide display devices (including those that can be head-mounted) that are compact and light. In addition, display devices with lens assemblies can provide a large field of view, thereby improving user experience with the display devices.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first lens could be termed a second lens, and, similarly, a second lens could be termed a first lens, without departing from the scope of the various described embodiments. The first lens and the second lens are both lenses, but they are not the same lens.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “exemplary” is used herein in the sense of “serving as an example, instance, or illustration” and not in the sense of “representing the best of its kind.”

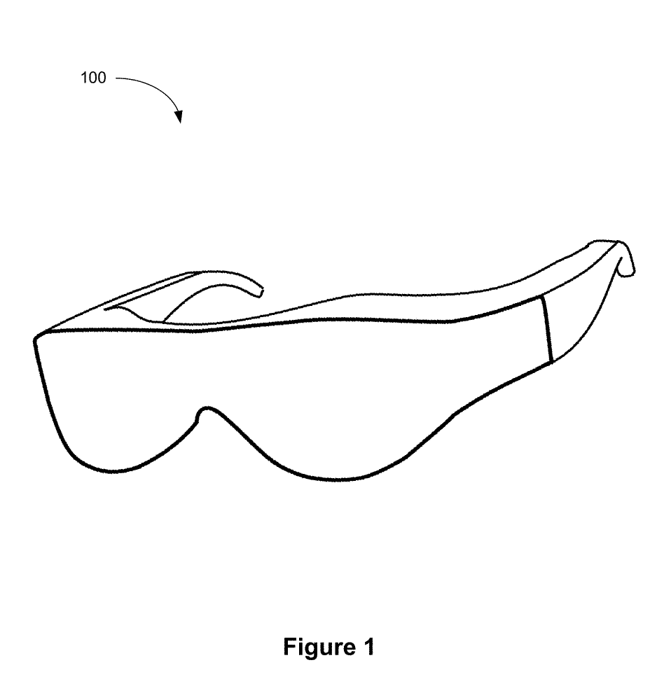

FIG. 1 illustrates display device 100 in accordance with some embodiments. In some embodiments, display device 100 is configured to be worn on a head of a user (e.g., by having the form of spectacles or eyeglasses, as shown in FIG. 1) or to be included as part of a helmet that is to be worn by the user. When display device 100 is configured to be worn on a head of a user or to be included as part of a helmet, display device 100 is called a head-mounted display. Alternatively, display device 100 is configured for placement in proximity of an eye or eyes of the user at a fixed location, without being head-mounted (e.g., display device 100 is mounted in a vehicle, such as a car or an airplane, for placement in front of an eye or eyes of the user).

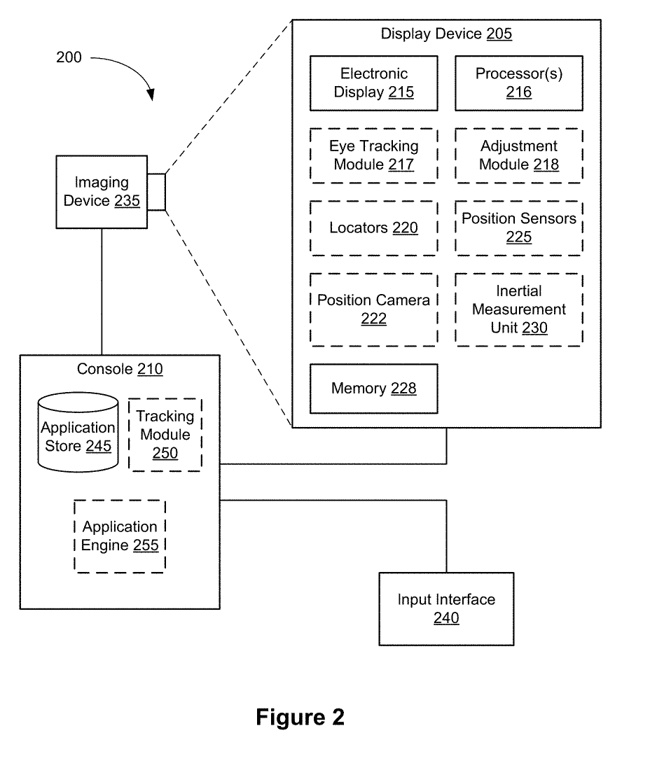

In some embodiments, display device 100 includes one or more components described below with respect to FIG. 2. In some embodiments, display device 100 includes additional components not shown in FIG. 2.

FIG. 2 is a block diagram of system 200 in accordance with some embodiments. The system 200 shown in FIG. 2 includes display device 205 (which corresponds to display device 100 shown in FIG. 1), imaging device 235, and input interface 240 that are each coupled to console 210. While FIG. 2 shows an example of system 200 including one display device 205, imaging device 235, and input interface 240, in other embodiments, any number of these components may be included in system 200. For example, there may be multiple display devices 205 each having associated input interface 240 and being monitored by one or more imaging devices 235, with each display device 205, input interface 240, and imaging devices 235 communicating with console 210. In alternative configurations, different and/or additional components may be included in system 200. For example, in some embodiments, console 210 is connected via a network (e.g., the Internet) to system 200 or is self-contained as part of display device 205 (e.g., physically located inside display device 205). In some embodiments, display device 205 is used to create mixed reality by adding in a view of the real surroundings. Thus, display device 205 and system 200 described here can deliver virtual reality, mixed reality, and augmented reality.

In some embodiments, as shown in FIG. 1, display device 205 is a head-mounted display that presents media to a user. Examples of media presented by display device 205 include one or more images, video, audio, or some combination thereof. In some embodiments, audio is presented via an external device (e.g., speakers and/or headphones) that receives audio information from display device 205, console 210, or both, and presents audio data based on the audio information. In some embodiments, display device 205 immerses a user in a virtual environment.

In some embodiments, display device 205 also acts as an augmented reality (AR) headset. In these embodiments, display device 205 augments views and of a physical, real-world environment with computer-generated elements (e.g., images, video, sound, etc.). Moreover, in some embodiments, display device 205 is able to cycle between different types of operation. Thus, display device 205 operate as a virtual reality (VR) device, an AR device, as glasses or some combination thereof (e.g., glasses with no optical correction, glasses optically corrected for the user, sunglasses, or some combination thereof) based on instructions from application engine 255.

Display device 205 includes electronic display 215, one or more processors 216, eye tracking module 217, adjustment module 218, one or more locators 220, one or more position sensors 225, one or more position cameras 222, memory 228, inertial measurement unit (IMU) 230, or a subset or superset thereof (e.g., display device 205 with electronic display 215, one or more processors 216, and memory 228, without any other listed components). Some embodiments of display device 205 have different modules than those described here. Similarly, the functions can be distributed among the modules in a different manner than is described here.

One or more processors 216 (e.g., processing units or cores) execute instructions stored in memory 228. Memory 228 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 228, or alternately the non-volatile memory device(s) within memory 228, includes a non-transitory computer readable storage medium. In some embodiments, memory 228 or the computer readable storage medium of memory 228 stores the following programs, modules and data structures, or a subset or superset thereof:
instructions for outputting a respective pattern of light from the two-dimensional array of pixels; and
instructions for relaying, using the lens assembly, the respective pattern of light from the two-dimensional array of pixels to a pupil of an eye of a user.

Electronic display 215 displays images to the user in accordance with data received from console 210 and/or processor(s) 216. In various embodiments, electronic display 215 may comprise a single adjustable electronic display element or multiple adjustable electronic displays elements (e.g., a display for each eye of a user). The adjustable electronic display element may be flat, cylindrically curved, or have some other shape.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed.

Eye tracking module 217 determines locations of each pupil of a user's eyes. In some embodiments, eye tracking module 217 instructs electronic display 215 to illuminate the eyebox with IR light (e.g., via IR emission devices in the display element).

A portion of the emitted IR light will pass through the viewing user's pupil and be retro-reflected from their retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 217 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image—and eye tracking module 217 maps the locations of the user's pupil while looking at the reference points to corresponding signals received on the IR tracking array). As mentioned above, in some embodiments, system 200 may use other eye tracking systems than the embedded IR one described above.

Adjustment module 218 generates an image frame based on the determined locations of the pupils. In some embodiments, adjustment module 218 adjusts an output (i.e. the generated image frame) of electronic display 215 based on the detected locations of the pupils. In some embodiments, adjustment module 218 instructs portions of electronic display 215 to pass image light to the determined locations of the pupils. In some embodiments, adjustment module 218 also instructs the electronic display to not pass image light to positions other than the determined locations of the pupils. Adjustment module 218 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses, or some combination thereof.

In some embodiments, adjustment module 218 is configured to instruct the display elements to not use every pixel (e.g., one or more light emission devices), such that black spaces aperture the diverging light to abut the image together from the retinal perspective. In addition, in some embodiments, gaps are created between the pixel groups to match divergence of the light source array and the magnification of the group of pixels as it transverses through the optical system and fully fills the lenslet. In some embodiments, adjustment module 218 determines, for a given position of an eye, which pixels are turned on and which pixels are turned off—with the resulting image being projected on the eye's retina.

Optional locators 220 are objects located in specific positions on display device 205 relative to one another and relative to a specific reference point on display device 205. A locator 220 may be a light emitting diode (LED), a corner cube reflector, a reflective marker, a type of light source that contrasts with an environment in which display device 205 operates, or some combination thereof. In embodiments where locators 220 are active (i.e., an LED or other type of light emitting device), locators 220 may emit light in the visible band (e.g., about 400 nm to 750 nm), in the infrared band (e.g., about 750 nm to 1 mm), in the ultraviolet band (about 100 nm to 400 nm), some other portion of the electromagnetic spectrum, or some combination thereof.

In some embodiments, locators 220 are located beneath an outer surface of display device 205, which is transparent to the wavelengths of light emitted or reflected by locators 220 or is thin enough to not substantially attenuate the wavelengths of light emitted or reflected by locators 220. Additionally, in some embodiments, the outer surface or other portions of display device 205 are opaque in the visible band of wavelengths of light. Thus, locators 220 may emit light in the IR band under an outer surface that is transparent in the IR band but opaque in the visible band.

IMU 230 is an electronic device that generates fast calibration data based on measurement signals received from one or more position sensors 225. Position sensor 225 generates one or more measurement signals in response to motion of display device 205. Examples of position sensors 225 include: one or more accelerometers, one or more gyroscopes, one or more magnetometers, another suitable type of sensor that detects motion, a type of sensor used for error correction of IMU 230, or some combination thereof. Position sensors 225 may be located external to IMU 230, internal to IMU 230, or some combination thereof.

Based on the one or more measurement signals from one or more position sensors 225, IMU 230 generates fast calibration data indicating an estimated position of display device 205 relative to an initial position of display device 205. For example, position sensors 225 include multiple accelerometers to measure translational motion (forward/back, up/down, left/right) and multiple gyroscopes to measure rotational motion (e.g., pitch, yaw, roll). In some embodiments, IMU 230 rapidly samples the measurement signals and calculates the estimated position of display device 205 from the sampled data. For example, IMU 230 integrates the measurement signals received from the accelerometers over time to estimate a velocity vector and integrates the velocity vector over time to determine an estimated position of a reference point on display device 205. Alternatively, IMU 230 provides the sampled measurement signals to console 210, which determines the fast calibration data. The reference point is a point that may be used to describe the position of display device 205. While the reference point may generally be defined as a point in space; however, in practice the reference point is defined as a point within display device 205 (e.g., a center of IMU 230).

In some embodiments, IMU 230 receives one or more calibration parameters from console 210. As further discussed below, the one or more calibration parameters are used to maintain tracking of display device 205. Based on a received calibration parameter, IMU 230 may adjust one or more IMU parameters (e.g., sample rate). In some embodiments, certain calibration parameters cause IMU 230 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 235 generates calibration data in accordance with calibration parameters received from console 210. Calibration data includes one or more images showing observed positions of locators 220 that are detectable by imaging device 235. In some embodiments, imaging device 235 includes one or more still cameras, one or more video cameras, any other device capable of capturing images including one or more locators 220, or some combination thereof. Additionally, imaging device 235 may include one or more filters (e.g., used to increase signal to noise ratio). Imaging device 235 is configured to optionally detect light emitted or reflected from locators 220 in a field of view of imaging device 235. In embodiments where locators 220 include passive elements (e.g., a retroreflector), imaging device 235 may include a light source that illuminates some or all of locators 220, which retro-reflect the light towards the light source in imaging device 235. Slow calibration data is communicated from imaging device 235 to console 210, and imaging device 235 receives one or more calibration parameters from console 210 to adjust one or more imaging parameters (e.g., focal length, focus, frame rate, ISO, sensor temperature, shutter speed, aperture, etc.).

Input interface 240 is a device that allows a user to send action requests to console 210. An action request is a request to perform a particular action. For example, an action request may be to start or end an application or to perform a particular action within the application. Input interface 240 may include one or more input devices. Example input devices include: a keyboard, a mouse, a game controller, data from brain signals, data from other parts of the human body, or any other suitable device for receiving action requests and communicating the received action requests to console 210. An action request received by input interface 240 is communicated to console 210, which performs an action corresponding to the action request. In some embodiments, input interface 240 may provide haptic feedback to the user in accordance with instructions received from console 210. For example, haptic feedback is provided when an action request is received, or console 210 communicates instructions to input interface 240 causing input interface 240 to generate haptic feedback when console 210 performs an action.

Console 210 provides media to display device 205 for presentation to the user in accordance with information received from one or more of: imaging device 235, display device 205, and input interface 240. In the example shown in FIG. 1, console 210 includes application store 245, tracking module 250, and application engine 255. Some embodiments of console 210 have different modules than those described in conjunction with FIG. 1. Similarly, the functions further described below may be distributed among components of console 210 in a different manner than is described here.

When application store 245 is included in console 210, application store 245 stores one or more applications for execution by console 210. An application is a group of instructions, that when executed by a processor, generates content for presentation to the user. Content generated by an application may be in response to inputs received from the user via movement of display device 205 or input interface 240. Examples of applications include: gaming applications, conferencing applications, video playback application, or other suitable applications.

When tracking module 250 is included in console 210, tracking module 250 calibrates system 200 using one or more calibration parameters and may adjust one or more calibration parameters to reduce error in determination of the position of display device 205. For example, tracking module 250 adjusts the focus of imaging device 235 to obtain a more accurate position for observed locators on display device 205. Moreover, calibration performed by tracking module 250 also accounts for information received from IMU 230. Additionally, if tracking of display device 205 is lost (e.g., imaging device 235 loses line of sight of at least a threshold number of locators 220), tracking module 250 re-calibrates some or all of system 100.

In some embodiments, tracking module 250 tracks movements of display device 205 using slow calibration information from imaging device 235. For example, tracking module 250 determines positions of a reference point of display device 205 using observed locators from the slow calibration information and a model of display device 205. In some embodiments, tracking module 250 also determines positions of a reference point of display device 205 using position information from the fast calibration information. Additionally, in some embodiments, tracking module 250 may use portions of the fast calibration information, the slow calibration information, or some combination thereof, to predict a future location of display device 205. Tracking module 250 provides the estimated or predicted future position of display device 205 to application engine 255.

Application engine 255 executes applications within system 200 and receives position information, acceleration information, velocity information, predicted future positions, or some combination thereof of display device 205 from tracking module 250. Based on the received information, application engine 255 determines content to provide to display device 205 for presentation to the user. For example, if the received information indicates that the user has looked to the left, application engine 255 generates content for display device 205 that mirrors the user's movement in a virtual environment. Additionally, application engine 255 performs an action within an application executing on console 210 in response to an action request received from input interface 240 and provides feedback to the user that the action was performed. The provided feedback may be visual or audible feedback via display device 205 or haptic feedback via input interface 240.

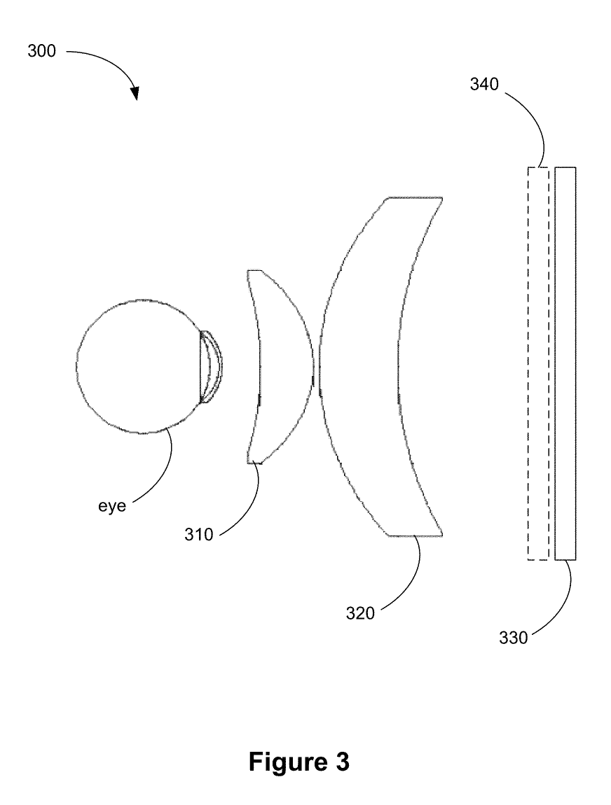

FIG. 3 is a schematic diagram illustrating a structure of display device 300 in accordance with some embodiments. Display device 300 includes two-dimensional array of pixels 330. Two-dimensional array of pixels 330 is configured to output a respective pattern of light (e.g., two-dimensional array of pixels 330 displays a particular image).

In some embodiments, two-dimensional array of pixels 330 is coupled with one or more backlights (e.g., cathode fluorescent lamp, light-emitting diode, etc.). In some embodiments, two-dimensional array of pixels 330 is configured to emit light without using separate backlights (e.g., two-dimensional array of pixels 330 includes an array of organic light-emitting diodes (OLEDs)).

In some embodiments, two-dimensional array of pixels 330 is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to provide no attenuation, while other liquid crystal cells may be set to provide maximum attenuation. As a result, two-dimensional array of pixels 330 outputs a respective pattern of light (e.g., a pattern of light that corresponds to an image displayed by two-dimensional array of pixels 330).

FIG. 3 also illustrates that display device 300 includes a lens assembly that is configured for relaying the respective pattern of light from two-dimensional array of pixels to a pupil of an eye of a user. The lens assembly includes two or more lenses (e.g., lens 310 and lens 320). A ray of light from a respective pixel of two-dimensional array of pixels 330 passes through the two or more lenses (e.g., lens 310 and lens 320).

The lens assembly shown in FIG. 3 provides several advantages over conventional display devices. For example, display devices need to be compact and light to improve user comfort in using such devices. While using fewer lenses (e.g., using only one lens) can reduce the size and weight of the display devices, the use of only one lens has several challenges when relaying high quality images. For example, images relayed by a single lens can suffer from various aberrations. In addition, it is challenging to relay high quality images with a single lens when a user's eye changes its position (e.g., a lateral position and/or an angular position of the eye).

The inventor of this application has found that the lens assembly shown in FIG. 3 can provide high quality images. In particular, various aberrations remain small for a range of a lateral position and an angular position of an eye (e.g., aberrations do not increase by more than 20% when the eye rotates by 20° and/or the eye moves laterally by 5 mm from its nominal position) when the lens assembly shown in FIG. 3 is used.

Furthermore, the lens assembly shown in FIG. 3 is lighter and more compact than other, more complex, lens assemblies (e.g., lens assemblies containing more than two lenses).

In some embodiments, the lens assembly includes a first converging lens (e.g., lens 310) and a second converging lens (e.g., lens 320).

In some embodiments, the first converging lens and the second converging lens are meniscus lenses (e.g., lens 310 is a convex-concave lens and lens 320 is a convex-concave lens).

In some embodiments, a convex surface of the first converging lens faces a convex surface of the second converging lens (e.g., convex surfaces of lens 310 and lens 320 face each other as shown in FIG. 3). This configuration reduces various aberrations (e.g., distortions and chromatic aberrations), thereby providing a sharp image across a field of view.

In some embodiments, the first converging lens and the second converging lens are spherical lenses (e.g., the first converging lens has two spherical optical surfaces and the second converging lens has two spherical optical surfaces).

In some embodiments, the lens assembly is configured so that the second converging lens is positioned adjacent to the two-dimensional array of pixels (e.g., in FIG. 3, a distance between lens 320 and two-dimensional array of pixels 330 is less than a distance between lens 310 and two-dimensional array of pixels 330).

In some embodiments, a diameter of the second converging lens (e.g., lens 320) is at least 50 mm (e.g., 50 mm, 55 mm, or 60 mm, etc.). In some embodiments, a size of the second converging lens (e.g., a diameter of the second converging lens) is determined based on a size of a display (e.g., two-dimensional array of pixels 330).

In some embodiments, a diameter of the first converging lens (e.g., lens 310) is at least 30 mm (e.g., 30 mm, 35 mm, 40 mm, or 45 mm, etc.). Because the first converging lens is smaller than the second converging lens, the overall weight of the lens assembly is reduced, which, in turn, reduces the weight of the display device.

In some embodiments, the center thickness of the first converging lens is at most 10 mm (e.g., 5 mm, 6 mm, 7 mm, 8 mm, 9 mm, or 10 mm). In some embodiments, a center thickness of the first converging lens is at least 8 mm (e.g., 8 mm, 9 mm, or 10 mm).

In some embodiments, a center thickness of the second converging lens is at most 14 mm (e.g., 5 mm, 6 mm, 7 mm, 8 mm, 9 mm, 10 mm, 11 mm, 12 mm, 13 mm, or 14 mm). This is significant, because in some cases, a converging lens with its center thickness more than 14 mm suffer from various defects, especially when the converging lens is made of plastic (e.g., polymethyl methacrylate, polystyrene, polycarbonate, etc.).

In some embodiments, an effective focal length of the lens assembly is less than 70 mm (e.g., between 10 mm and 70 mm, between 20 mm and 70 mm, between 30 mm and 70 mm, between 40 mm and 70 mm, between 50 mm and 70 mm, or between 60 mm and 70 mm). In some embodiments, an effective focal length of the lens assembly is less than 60 mm (e.g., between 10 mm and 60 mm, between 20 mm and 60 mm, between 30 mm and 60 mm, between 40 mm and 60 mm, or between 50 mm and 60 mm). In some embodiments, an effective focal length of the lens assembly is less than 50 mm (e.g., between 10 mm and 50 mm, between 20 mm and 50 mm, between 30 mm and 50 mm, or between 40 mm and 50 mm). In some embodiments, an effective focal length of the lens assembly is less than 40 mm (e.g., between 10 mm and 40 mm, between 20 mm and 40 mm, or between 30 mm and 40 mm). Thus, a size of the display device can be reduced by utilizing a lens assembly with a short effective focal length.

In some embodiments, an eye relief of the lens assembly is about 10 mm (e.g., the eye relief is between 5 mm and 15 mm).

In some embodiments, a viewing angle of the display device is about 100 degrees. In some embodiments, a viewing angle of the display device is at least 80 degrees. In some embodiments, a viewing angle of the display device is at least 90 degrees. In some embodiments, a viewing angle of the display device is at least 100 degrees. In some embodiments, a viewing angle of the display device is between 80 and 120 degrees. In some embodiments, a viewing angle of the display device is between 90 and 110 degrees. In some embodiments, a viewing angle of the display device is between 95 and 110 degrees. Thus, the display device provides a wide viewing angle, which improves user satisfaction with the display device.

In some embodiments, the two or more lenses are made of well-known optical materials, such as polymethyl methacrylate (PMMA), polycarbonate, polystyrene, and cyclo-olefin polymers.

In some embodiments, the two or more lenses have one or more coatings (e.g., anti-reflection coating, anti-scratch coating, anti-smudge coating, anti-fog coating, etc.).

In some embodiments, the two or more lenses are positioned on a same optical axis (e.g., in FIG. 3, lens 310 and lens 320 are positioned on a same optical axis).

In some embodiments, a distance from two-dimensional array of pixels 330 to the lens assembly (e.g., 26 mm) is greater than a distance from the lens assembly to the pupil of the eye of the user (e.g., 10 mm).

In some embodiments, the lens assembly is configured to project a demagnified image, of an image formed on two-dimensional array of pixels 330, on a retina of the eye of the user. In some embodiments, the image on the two-dimensional array of pixels includes a gap between pixels or subpixels. The gap makes the image appear as if the image is projected through a screen door, which is called herein a “screen door effect.” The screen door effect reduces user satisfaction with display devices. When a demagnified image is projected, the gap appears smaller on the retina of the eye of the user, thereby improving the quality of the image projected on the retina of the eye of the user, and accordingly, user satisfaction with display devices.

In some embodiments, the distance from the two-dimensional array of pixels to the pupil of the eye of the user is less than 100 mm (e.g., between 30 mm and 100 mm, between 40 mm and 100 mm, between 50 mm and 100 mm, between 60 mm and 100 mm, between 70 mm and 100 mm, between 80 mm and 100 mm, or between 90 mm and 100 mm). In some embodiments, the distance from the two-dimensional array of pixels to the pupil of the eye of the user is less than 90 mm (e.g., between 30 mm and 90 mm, between 40 mm and 90 mm, between 50 mm and 90 mm, between 60 mm and 90 mm, between 70 mm and 90 mm, or between 80 mm and 90 mm). In some embodiments, the distance from the two-dimensional array of pixels to the pupil of the eye of the user is less than 80 mm (e.g., between 30 mm and 80 mm, between 40 mm and 80 mm, between 50 mm and 80 mm, between 60 mm and 80 mm, or between 70 mm and 80 mm). In some embodiments, the distance from the two-dimensional array of pixels to the pupil of the eye of the user is less than 70 mm (e.g., between 30 mm and 70 mm, between 40 mm and 70 mm, between 50 mm and 70 mm, or between 60 mm and 70 mm). In some embodiments, the distance from the two-dimensional array of pixels to the pupil of the eye of the user is less than 60 mm (e.g., between 30 mm and 60 mm, between 40 mm and 60 mm, or between 50 mm and 60 mm). In some embodiments, the distance from the two-dimensional array of pixels to the pupil of the eye of the user is less than 50 mm (e.g., between 30 mm and 50 mm, or between 40 mm and 50 mm). Thus, the display device can be made compact by reducing the distance from the two-dimensional array of pixels to the pupil of the eye of the user.

In some embodiments, the two-dimensional array of pixels has a height of at least 50 mm (e.g., between 50 mm and 90 mm, between 50 mm and 80 mm, between 50 mm and 70 mm, or between 50 mm and 60 mm). In some embodiments, the two-dimensional array of pixels has a height of at least 60 mm (e.g., between 60 mm and 90 mm, between 60 mm and 80 mm, or between 60 mm and 70 mm). In some embodiments, the two-dimensional array of pixels has a height of at least 70 mm (e.g., between 70 mm and 90 mm, or between 70 mm and 80 mm). In some embodiments, the two-dimensional array of pixels has a width of at least 50 mm (e.g., between 50 mm and 90 mm, between 50 mm and 80 mm, between 50 mm and 70 mm, or between 50 mm and 60 mm). In some embodiments, the two-dimensional array of pixels has a width of at least 60 mm (e.g., between 60 mm and 90 mm, between 60 mm and 80 mm, or between 60 mm and 70 mm). In some embodiments, the two-dimensional array of pixels has a width of at least 70 mm (e.g., between 70 mm and 90 mm, or between 70 mm and 80 mm). This allows a large field of view, thereby allowing projection of a quality image on the retina of the eye of the user for various pupil positions.

In some embodiments, the display device of claim is a head-mounted display device (e.g., display device 100 in FIG. 1).

In some embodiments, the display device includes a diffraction film (e.g., diffraction film 340).

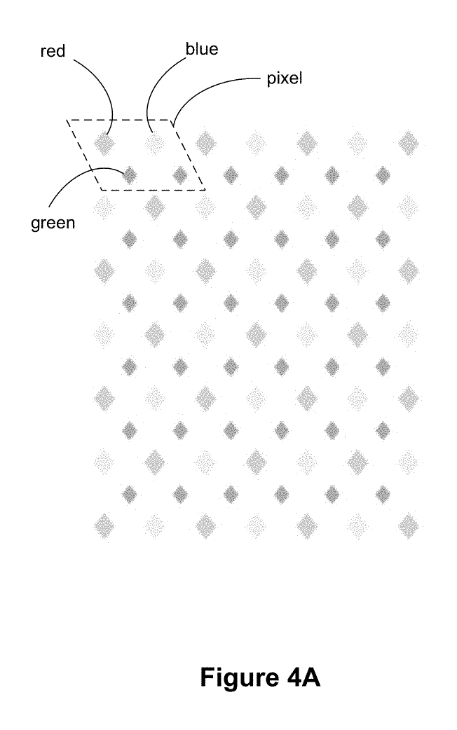

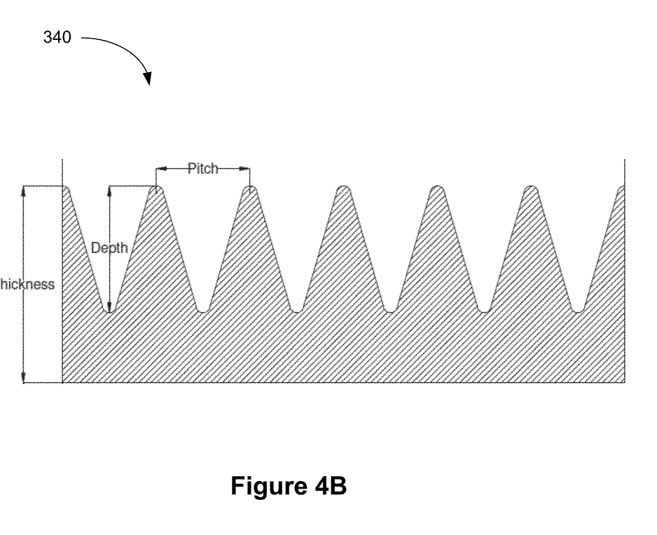

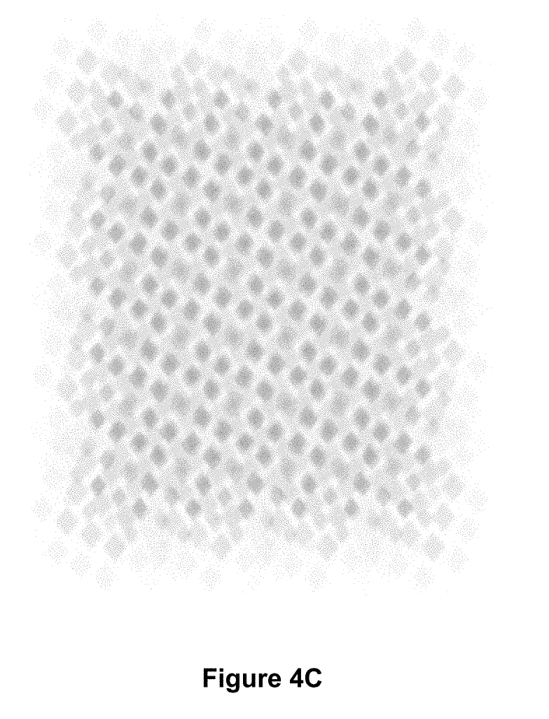

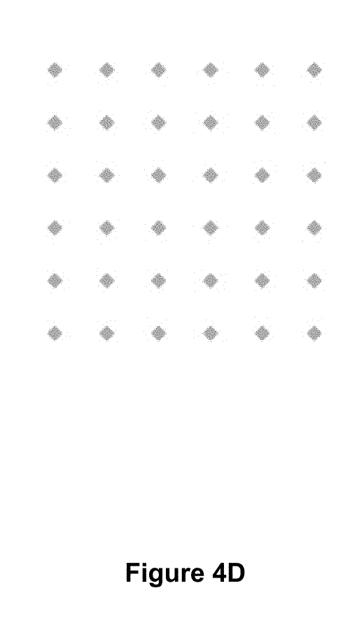

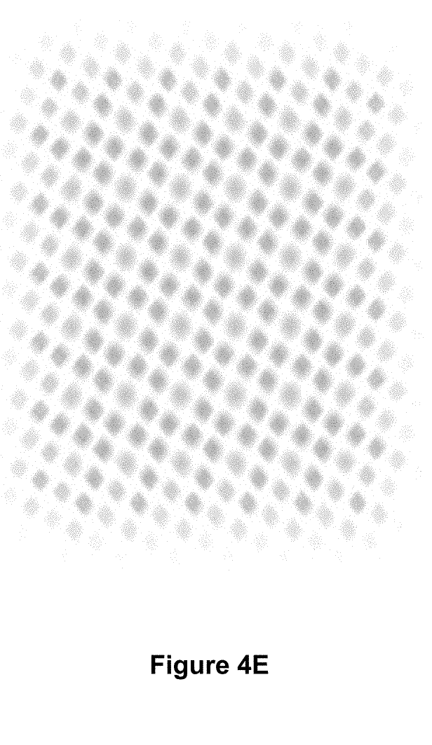

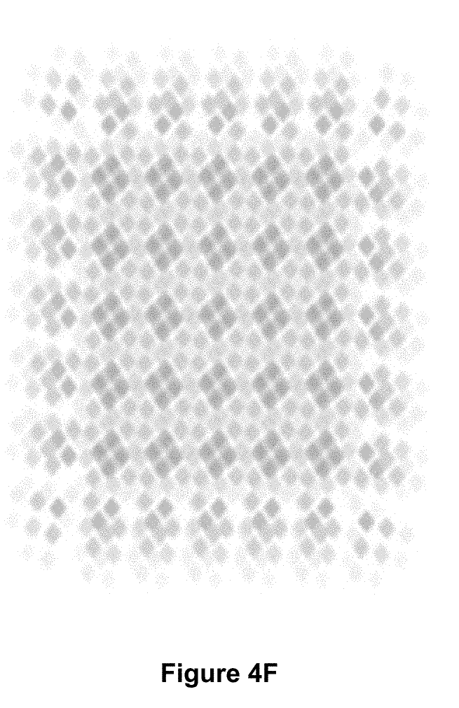

As shown in FIG. 3, display device 300 optionally includes diffraction film 340, which is described below with respect to FIGS. 4A-4C.

FIG. 4A is a plan view of an array of pixels in accordance with some embodiments.

As shown in FIG. 4A, each pixel includes a plurality of subpixels, where each subpixel corresponds to a respective color. For example, each pixel may include three subpixels, each subpixel outputting light of one of red, green, and blue colors. In another example, each pixel may include four subpixels, each subpixel outputting to one of red, green, blue, and yellow colors (e.g., a pixel in FIG. 4A includes one red subpixel, one blue subpixel, and two green subpixels). In some cases, this is enabled by placing different color filters in front of the subpixels. In some embodiments, the subpixels in each pixel have the same size (e.g., the red subpixel, the green subpixel, and the blue subpixel have the same size), while in some other embodiments, the subpixels have different sizes (e.g., to compensate for different intensities of light of different colors).

FIG. 4A also illustrates that there are spaces or “gaps” between subpixels, which generates the screen door effect described above.

FIG. 4B is a schematic diagram illustrating a structure of a diffraction film in accordance with some embodiments.

The diffraction film includes a periodic structure (e.g., a repeating pattern of peaks and valleys). In some embodiments, the periodic structure is characterized by a pitch and a depth of the periodic structure. In addition, the diffraction film is also characterized by its thickness. In some embodiments, the pitch, the depth, and the thickness are selected to cause diffraction of the light from the subpixels.

In some embodiments, the pitch of the periodic structure in the diffraction film corresponds to a pitch of subpixels (e.g., 50 μm). The depth is between 1 and 1.4 μm, based on a particular wavelength of light (e.g., the depth is a multiple of a reference wavelength, such as 573 nm). In some embodiments, the pitch of the periodic structure in the diffraction film corresponds to a fraction of a pitch of pixels (e.g., 10%, 20%, 30%, 40%, 50%, 60%, 70%, 80%, or 90% of the pitch of subpixels). For example, the pitch of the periodic structure in the diffraction film corresponds to one half of the pitch of subpixels (e.g., when the subpixels have 50 μm pitch, the periodic structure in the diffraction film has 25 μm pitch).

The inventor of this application has discovered that a pitch of less than 60 μm works well for an array of pixels. For example, 56.29 μm pitch, 1.146 μm depth, and 3000 μm thickness works well for an array of pixels, where blue, red, and green subpixels have a diamond shape, blue and red subpixels are each 22 μm wide and 22 μm tall, blue and red subpixels each have 17 μm long sides, a green subpixel is 15 μm wide and 15 μm tall, a green subpixel has 13 μm long sides, blue and red subpixels within a pixel are separated by 34 μm, a gap between a green subpixel and a blue subpixel within a pixel is 24 μm, a gap between a green subpixel and a red subpixel within a pixel is 24 μm, a gap between two green subpixels within a pixel is 39 μm, a gap between two green subpixels in two adjacent pixels is 40 μm.

FIG. 4C is an image of the array of pixels, shown in FIG. 4A, with diffraction film 340 positioned over the array of pixels in accordance with some embodiments.

As shown in FIG. 4C, the diffraction caused by diffraction film 340 spreads light from each subpixel over multiple spots. As a result, the gap between subpixels is at least partially filled with the diffraction pattern. Accordingly, the gap is less visible to the user and the screen door effect is reduced. Thus, diffraction film 340 can be used to reduce the screen door effect.

FIG. 4D is a plan view of an array of pixels in accordance with some embodiments. FIG. 4D is similar to FIG. 4A, except that only subpixels that correspond to a same color (e.g., green subpixels) are activated. As with FIG. 4A, the spacing between subpixels generates the screen door effect, which can be perceived by a user and reduces user satisfaction with display devices.

FIG. 4E is an image of the array of pixels, shown in FIG. 4D, with diffraction film 340 positioned over the array of pixels in accordance with some embodiments.

FIG. 4E shows that the diffraction caused by diffraction film 340 spreads light from each subpixel over multiple spots. As a result, the gap between subpixels is at least partially filled with the diffraction pattern. Accordingly, the gap is less visible to the user and the screen door effect is reduced. Thus, as shown with FIG. 4C, diffraction film 340 can be used to reduce the screen door effect.

FIG. 4F is an image of the array of pixels, shown in FIG. 4D, with another diffraction film positioned over the array of pixels in accordance with some embodiments. The diffraction film used for obtaining the image shown in FIG. 4F is different from the diffraction film used for obtaining the images shown in FIGS. 4C and 4E, and thus, causes a different diffraction pattern. Comparison of FIGS. 4E and 4F show that the gap between subpixels is further reduced in FIG. 4F.

As mentioned above, the inventor of this application has discovered that a pitch of less than 60 μm works well for an array of pixels. In obtaining the image shown in FIG. 4F, 28.15 μm pitch, 1.60 μm depth, and 1000 μm thickness works especially well for the array of pixels shown in FIG. 4C. In particular, the smaller pitch allowed the use of a thinner (e.g., 1000 μm thickness) diffraction film, which in turn reduces the size and weight of the lens assembly.

In some embodiments, the diffraction film has a pitch less than 50 μm. In some embodiments, the diffraction film has a pitch less than 40 μm. In some embodiments, the diffraction film has a pitch less than 30 μm. In some embodiments, the diffraction film has a pitch less than 20 μm. In some embodiments, the diffraction film has a pitch less than 10 μm. In some embodiments, the diffraction film has a pitch more than 50 μm. In some embodiments, the diffraction film has a pitch more than 40 μm. In some embodiments, the diffraction film has a pitch more than 30 μm. In some embodiments, the diffraction film has a pitch more than 20 μm. In some embodiments, the diffraction film has a pitch more than 10 μm. In some embodiments, the diffraction film has a pitch between 10 μm and 50 μm. In some embodiments, the diffraction film has a pitch between 20 μm and 50 μm. In some embodiments, the diffraction film has a pitch between 30 μm and 50 μm. In some embodiments, the diffraction film has a pitch between 40 μm and 50 μm. In some embodiments, the diffraction film has a pitch between 10 μm and 40 μm. In some embodiments, the diffraction film has a pitch between 20 μm and 40 μm. In some embodiments, the diffraction film has a pitch between 30 μm and 40 μm. In some embodiments, the diffraction film has a pitch between 10 μm and 30 μm. In some embodiments, the diffraction film has a pitch between 20 μm and 30 μm. In some embodiments, the diffraction film has a pitch between 25 μm and 35 μm. In some embodiments, the diffraction film has a pitch between 15 μm and 45 μm.

In some embodiments, the diffraction film has a depth less than 2 μm. In some embodiments, the diffraction film has a depth less than 1.8 μm. In some embodiments, the diffraction film has a depth less than 1.6 μm. In some embodiments, the diffraction film has a depth less than 1.4 μm. In some embodiments, the diffraction film has a depth less than 1.2 μm. In some embodiments, the diffraction film has a depth less than 1 μm. In some embodiments, the diffraction film has a depth less than 0.8 μm. In some embodiments, the diffraction film has a depth less than 0.6 μm. In some embodiments, the diffraction film has a depth more than 2 μm. In some embodiments, the diffraction film has a depth more than 1.8 μm. In some embodiments, the diffraction film has a depth more than 1.6 μm. In some embodiments, the diffraction film has a depth more than 1.4 μm. In some embodiments, the diffraction film has a depth more than 1.2 μm. In some embodiments, the diffraction film has a depth more than 1 μm. In some embodiments, the diffraction film has a depth more than 0.8 μm. In some embodiments, the diffraction film has a depth more than 0.6 μm. In some embodiments, the diffraction film has a depth between than 0.6 μm and 2.0 μm. In some embodiments, the diffraction film has a depth between than 0.7 μm and 1.9 μm. In some embodiments, the diffraction film has a depth between than 0.8 μm and 1.8 μm. In some embodiments, the diffraction film has a depth between than 0.9 μm and 1.7 μm. In some embodiments, the diffraction film has a depth between than 1.0 μm and 1.6 μm. In some embodiments, the diffraction film has a depth between than 1.1 μm and 1.5 μm. In some embodiments, the diffraction film has a depth between than 1.2 μm and 1.4 μm.

In some embodiments, the diffraction film has a thickness less than 3000 μm. In some embodiments, the diffraction film has a thickness less than 2500 μm. In some embodiments, the diffraction film has a thickness less than 2000 μm. In some embodiments, the diffraction film has a thickness less than 1500 μm. In some embodiments, the diffraction film has a thickness less than 1000 μm. In some embodiments, the diffraction film has a thickness less than 500 μm. In some embodiments, the diffraction film has a thickness less than 200 μm. In some embodiments, the diffraction film has a thickness less than 100 μm. In some embodiments, the diffraction film has a thickness more than 3000 μm. In some embodiments, the diffraction film has a thickness more than 2500 μm. In some embodiments, the diffraction film has a thickness more than 2000 μm. In some embodiments, the diffraction film has a thickness more than 1500 μm. In some embodiments, the diffraction film has a thickness more than 1000 μm. In some embodiments, the diffraction film has a thickness more than 500 μm. In some embodiments, the diffraction film has a thickness more than 200 μm. In some embodiments, the diffraction film has a thickness more than 100 μm. In some embodiments, the diffraction film has a thickness more than 100 μm. In some embodiments, the diffraction film has a thickness between 500 μm and 3500 μm. In some embodiments, the diffraction film has a thickness between 500 μm and 2500 μm. In some embodiments, the diffraction film has a thickness between 500 μm and 1500 μm. In some embodiments, the diffraction film has a thickness between 700 μm and 1300 μm. In some embodiments, the diffraction film has a thickness between 800 μm and 1200 μm. In some embodiments, the diffraction film has a thickness between 900 μm and 1100 μm. In some embodiments, the diffraction film has a thickness between 500 μm and 1500 μm. In some embodiments, the diffraction film has a thickness between 400 μm and 1400 μm. In some embodiments, the diffraction film has a thickness between 300 μm and 1300 μm. In some embodiments, the diffraction film has a thickness between 200 μm and 1200 μm. In some embodiments, the diffraction film has a thickness between 100 μm and 1100 μm.

Although FIG. 4F shows the image of an array of pixels when the array of pixels is emitting light of a same color (e.g., when only subpixels that correspond to green light are activated), the diffraction film used for obtaining the image shown in FIG. 4F can be used for causing diffraction of light in multiple colors (e.g., the diffraction film used for obtaining the image shown in FIGS. 4C and 4E can cause diffraction of a single color as shown in FIG. 4E or multiple colors as shown in FIG. 4C).

In accordance with some embodiments, a lens assembly includes two or more lenses (e.g., lens 310 and lens 320 in FIG. 3) for relaying a respective pattern of light from a two-dimensional array of pixels (e.g., two-dimensional array of pixels 330) to a pupil of an eye of a user. The two or more lenses are configured in such a way that a ray of light from a respective pixel of the two-dimensional array of pixels passes through the two or more lenses of the lens assembly.

In accordance with some embodiments, a method is performed at a display device includes a two-dimensional array of pixels and a lens assembly (e.g., FIG. 3). The method includes outputting a respective pattern of light from the two-dimensional array of pixels; and relaying, using the lens assembly, the respective pattern of light from the two-dimensional array of pixels to a pupil of an eye of a user. The lens assembly includes two or more lenses. The two or more lenses are configured in such a way that a ray of light from a respective pixel of the two-dimensional array of pixels passes through the two or more lenses of the lens assembly.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A display device, comprising:
a two-dimensional array of pixels configured for outputting a respective pattern of light;
a lens assembly configured for relaying the respective pattern of light from the two-dimensional array of pixels to a pupil of an eye of a user, wherein the lens assembly includes two or more lenses and the two or more lenses are configured in such a way that a ray of light from a respective pixel of the two-dimensional array of pixels passes through the two or more lenses of the lens assembly.

2. The display device of claim 1, wherein the display device is a head-mounted display device.

3. The display device of claim 1, wherein a distance from the two-dimensional array of pixels to the lens assembly is greater than a distance from the lens assembly to the pupil of the eye of the user.

4. The display device of claim 1, wherein the distance from the two-dimensional array of pixels to the pupil of the eye of the user is less than 100 mm.

5. The display device of claim 1, wherein the two-dimensional array of pixels has a height of at least 50 mm.

6. The display device of claim 1, wherein the lens assembly is configured to project a demagnified image, of an image formed on the two-dimensional array of pixels, on a retina of the eye of the user.

7. The display device of claim 1, wherein the lens assembly includes a first converging lens and a second converging lens.

8. The display device of claim 7, wherein the first converging lens and the second converging lens are meniscus lenses.

9. The display device of claim 8, wherein:
the first converging lens is a convex-concave lens;
the second converging lens is a convex-concave lens; and
a convex surface of the first converging lens faces a convex surface of the second converging lens.

10. The display device of claim 7, wherein the lens assembly is configured so that the second converging lens is positioned adjacent to the two-dimensional array of pixels.

11. The display device of claim 10, wherein a diameter of the second converging lens is at least 50 mm.

12. The display device of claim 10, wherein a diameter of the first converging lens is at least 30 mm.

13. The display device of claim 10, wherein a center thickness of the first converging lens is at most 10 mm.

14. The display device of claim 10, wherein a center thickness of the second converging lens is at most 14 mm.

15. The display device of claim 1, wherein an effective focal length of the lens assembly is less than 70 mm.

16. The display device of claim 1, wherein an eye relief of the lens assembly is about 10 mm.

17. The display device of claim 1, wherein a viewing angle of the display device is about 100 degrees.

18. The display device of claim 1, wherein the two or more lenses are positioned on a same optical axis.

19. A lens assembly, comprising:
two or more lenses for relaying a respective pattern of light from a two-dimensional array of pixels to a pupil of an eye of a user, wherein the two or more lenses are configured in such a way that a ray of light from a respective pixel of the two-dimensional array of pixels passes through the two or more lenses of the lens assembly.

20. A method, comprising:
at a display device, comprising a two-dimensional array of pixels and a lens assembly:
outputting a respective pattern of light from the two-dimensional array of pixels; and
relaying, using the lens assembly, the respective pattern of light from the two-dimensional array of pixels to a pupil of an eye of a user, wherein the lens assembly includes two or more lenses and the two or more lenses are configured in such a way that a ray of light from a respective pixel of the two-dimensional array of pixels passes through the two or more lenses of the lens assembly.
